(19) United States
(12) Patent Application Publication
(10) Pub. No.: US 2011/0100155 A1
(43) Pub. Date: May 5, 2011

(54) STEERING WHEEL FOR A VEHICLE

(75) Inventors: Thomas JENNY, Alsbach-Hahnlein (DE); Ulrich RICK, Braunweiler (DE)

(73) Assignee: GM GLOBAL TECHNOLOGY OPERATIONS, INC., Detroit, MI (US)

(21) Appl. No.: 12/883,107

(22) Filed: Sep. 15, 2010

(30) Foreign Application Priority Data
Sep. 16, 2009 (DE) 102009041713.3

(51) Int. Cl. B62D 1/04

(52) U.S. Cl. 74/552

(57) ABSTRACT

A steering wheel for a vehicle is provided that includes, but is not limited to a first cladding element that includes, but is not limited to a support material and a textile covering with cutting and/or joining points. The textile covering at least partially forms a visible surface of the first cladding element. The steering wheel has at least one constructive device for receiving the cutting and/or joining points and/or for screening the cutting and/or joining points.

### CROSS-REFERENCE TO RELATED APPLICATION

This application claims priority to German Patent Application No. 102009041713.3, filed Sep. 16, 2009, which is incorporated herein by reference in its entirety.

### TECHNICAL FIELD

The invention relates to a steering wheel for a vehicle having a first cladding element, which comprises a textile covering with cutting and/or joining points, wherein the textile covering at least partially forms a visible surface of the first cladding element.

### BACKGROUND

Steering wheels are built into vehicles, in particular automobiles, and are sufficiently known. Usually steering wheels are disposed in a driver area of the vehicle and are suitable for and/or configured to steer and/or control the vehicle. Steering wheels having a textile covering are also known from the prior art.

Document DE 191 4962 U describes a steering wheel sleeve made of textile, rubber, or plastic in the form of an annular strip. The annular strip has annular strip edges which are adapted for indirect mutual connection (tie cord, belt, strap) or for direct connection (hooks, zipper, snap fastener). Document DE 10 2006 055 488 A1, which probably forms the nearest prior art, discloses a control element for a vehicle made of a flexible material such as, for example, a textile fabric, which is suitable for being adapted to a curved surface of a steering wheel in such a manner that the control element abuts positively against the curved surface. The control element comprises a fastening system that can be configured as a clip, a snap, a Velcro connection, an adhesive connection or a sewn seam.

It is at least one object of the invention to design a steering wheel in an attractive and at the same time functional manner. In addition, other objects, desirable features, and characteristics will become apparent from the subsequent summary and detailed description, and the appended claims, taken in conjunction with the accompanying drawings and this background.

### SUMMARY

A steering wheel is proposed which can be disposed and/or is disposed in a vehicle. The steering wheel is preferably configured for integration in an automobile, in particular in front of a driver's seat. The steering wheel is suitable for and/or configured to steer and/or control the vehicle. The steering wheel optionally comprises a steering wheel skeleton and/or an airbag module, which is disposed in a hub region of the steering wheel and is configured as a driver frontal airbag. The airbag module preferably has an airbag module cover with an opening region. The opening region is usually configured to be linear. The airbag module opens in the opening region in order to allow an airbag located in the airbag module to escape from the airbag module in the event of an accident.

The steering wheel has a cladding element. The cladding element preferably covers and/or surrounds the steering wheel skeleton at least partially. Optionally, the cladding element can be configured as a steering wheel rim cover, a steering wheel spoke cover, a steering wheel hub cover and/or an airbag module cover. Also feasible here are all further encasements which at least partially cover and/or surround and/or encase the steering wheel skeleton or the cladding element(s). For example, mention may be made here of a control panel, which is disposed on the steering wheel and is suitable and/or configured for controlling electrical equipment such as, for example, a radio. In particular, the cladding element is suitable and/or configured for improving a grip and/or feel of the steering wheel.

In a preferred embodiment the cladding element is configured to be detachable, in particular it can be removed from the steering wheel skeleton free from damage. In another possible configuration, the cladding element is non-detachably connected to the steering wheel skeleton. In particular, the airbag module cover is non-detachably connected to the airbag module.

The cladding element comprises a support material. The support material is preferably formed from plastic and/or rubber. In particular, the support material has an upper side, at least one side surface, and a lower side. Usually the upper side is facing a vehicle driver and the lower side is arranged so that it is not visible and/or is concealed for the vehicle driver.

The cladding element furthermore has a textile covering with cutting and/or joining points. The textile covering preferably covers the upper side of the support material. In particular, the textile covering is connected to the upper side of the support material. It can be applied directly to the support material without an intermediate layer. It is also feasible for the textile covering to be applied indirectly to the support material, with one or a plurality of intermediate layers. The textile covering preferably has a support film and/or coating on a side facing the support material. For example, the support film and/or coating comprise a barrier layer and/or a composite material which is connected to the support material. The connection between textile covering and the support layer can optionally be made by low-pressure back injection molding, gluing, laminating, thermal introduction of heat such as, for example, welding, lasers, etc. or by other suitable joining methods.

Optionally, the textile covering can completely cover the upper side of the support material. However, it is also feasible that the textile covering covers the upper side only partially and/or in sections and/or with gaps. It is also possible that the textile covering covers the upper side continuously over the entire surface or over the entire surface with gaps, e.g. in a grid fashion. The textile covering preferably covers the upper side in a regular and/or irregular pattern. In particular, the textile covering covers the upper side in the form of a sign, letter, logo, image etc. In the aforesaid variant, the textile covering can be disposed, for example, adjacent to and/or in combination with another covering, e.g. made of leather, metal, and or fur, or adjacent to and/or in combination with a support material without a covering.

The textile covering preferably comprises fibers such as, for example, natural fibers and/or synthetic fibers. In particular, the textile covering comprises fibers made of cotton, silk, polyester, and/or polyamide. It is particularly preferable if the fibers form a surface structure which can be configured, for example, as a material, woven fabric, knitted fabrics, and/or knit fabrics. Optionally the textile covering comprises nonwoven and/or felt.

Preferably, the cutting and/or joining points of the textile covering are disposed at the edge and/or in the edge zone of the textile covering and/or the cutting and/or joining points form the edge zone. In particular the cutting and/or joining points comprise a surface which is enclosed by a parallel to the edge and the edge itself. Optionally, the distance between the parallels and the edge is approximately 2 cm, preferably approximately 1 cm, in particular approximately 0.5 cm.

The textile covering at least partially forms a visible surface of the support material. The textile covering preferably forms a cover layer of the cladding element. Usually the textile covering is integrated as a decorative covering and/or design element on the upper side of the support material, which combines visual and haptic advantages.

According to an embodiment of the invention, the steering wheel has at least one constructive device for receiving the cutting and/or joining points and/or for screening the cutting and/or joining points. In many preferred embodiments of the invention, the constructive device has a length of at least approximately 5 mm, preferably of at least approximately 15 mm, in particular of at least approximately 30 mm, especially of at least approximately 50 mm.

It is at least one advantage of the embodiments of the invention that any detachment and/or fraying of the cutting and/or joining points of the textile covering can be avoided and/or prevented by the constructive device. This is of particular advantage since cladding elements of the steering wheel are subjected to continuous touching contact by the driver and thus can become worn and/or abraded more easily and/or more rapidly. A further advantage of the embodiments of the invention is that any detachment of the textile covering can be effectively counteracted and at the same time, tolerances in textile to support material positioning and in textile cutting can be compensated.

In a preferred embodiment of the invention, the steering wheel has a second cladding element that adjoins the first cladding element via a join. The second cladding element is preferably configured as the first cladding element and/or has some identical or the same properties and/or features as the first cladding element. In particular, it is possible that the second cladding element has a support material and a textile covering with cutting and/or joining points which can be configured as described previously. It is also feasible that the second cladding element can have the already-described steering wheel skeleton covers and/or steering wheel encasements.

One possible embodiment of the invention provides that the constructive device comprises a beading and/or a groove. The beading and/or groove is preferably formed by an indentation in the support material of the first cladding element. In particular, the beading and/or groove is disposed on the upper side and/or a side surface of the first cladding element. Optionally, the beading and/or groove is disposed in front of the join to the second cladding element, preferably at a distance of up to approximately 10 mm, in particular of up to approximately 6 mm, especially of up to approximately 3 mm. It is particularly preferable if the beading and/or groove is disposed in the area of the join and/or at least partially forms this. In this case, the beading and/or groove can be disposed simultaneously in the support material of the first and second cladding element. It is also conceivable that the beading and/or groove are disposed in the opening area of the airbag module cover and/or the preferably linear opening region.

Usually, the beading and/or groove has a base and an opening directed towards the upper side and/or a side surface of the support material. Optionally, the beading and/or groove can be configured in a funnel shape or cup shape or depression shape in a cross-section perpendicular to the longitudinal extension. It is feasible that a side wall or side walls of the beading and/or groove slope downward at angles of preferably up to 30 degrees in particular of up to approximately 60 degrees, especially of up to approximately 90 degrees from the upper side and/or the side surface to the base of the beading and/or groove, the free intermediate angle between an imaginary plane of the upper side and the side wall being measured.

It is particularly preferred if the cutting and/or joining points are disposed and/or fastened in the beading and/or groove. In particular, the cutting and/or joining points are glued in the beading and/or groove.

In a further possible embodiment of the invention, the beading and/or groove has a lip. The lip is preferably disposed in the beading and/or in the groove, in particular the lip extends from the base in the direction of the opening of the beading and/or groove. The length of the lip can correspond to a beading depth and/or groove depth and/or coincide with this. Optionally, the lip extends completely from the base to the upper side and/or the side surface of the support material. However, it is also feasible that the lip is configured to be shorter than the beading and/or groove depth. Thus, the lip can have a length of preferably up to approximately 75%, in particular of up to approximately 50%, especially of up to approximately 25% of the beading and/or groove depth. Optionally, the lip can protrude from the base or from the wall of the beading or groove at an angle enclosed by said lip and the base of the beading and/or groove of up to approximately 90 degrees, preferably of up to approximately 60 degrees, in particular of up to approximately 30 degrees.

A further feasible embodiment of the invention provides that the cutting and/or joining points are fastened on the lip. The cutting and/or joining points are preferably adhesively bonded to the lip. It is also feasible that the cutting and/or joining points are adhesively bonded in the beading and/or groove and at the same time on the lip.

It is advantageous if the cutting and/or joining points or the edge of the textile covering are protected from continuous access and/or abrasion by being disposed in the beading and/or groove and/or on the lip.

The support material, in particular the support material of the airbag module cover, is optionally weakened in the area of the beading and/or groove. Preferably the underside of the support material has a recess and/or weakening. Especially, the recess and/or the weakening forms the opening region of the airbag module cover.

It should be advantageously mentioned that the textile covering does not require any separate, usually unattractive, weakening in order not to prevent the airbag module cover from opening in the event of an activation of the airbag module. This is in particular possible since the cutting and/or joining points are disposed in the beading and/or groove and the textile covering therefore does not need to tear open. Consequently, an opening and/or tearing functionality of the airbag module cover can be fully ensured.

In a further preferred embodiment, the covering has at least one envelope as the, and/or at the, cutting and/or joining points. The envelope is preferably laid around at least one side surface of the support material of the first or the second cladding element. The envelope can optionally also be laid around a side surface of the support material of the airbag module cover, which is disposed in the opening region and/or forms the preferably linear opening region.

Optionally, the envelope can completely cover the side surface. The envelope preferably covers at least approximately 75% of the side surface, in particular at least approximately 50%, especially at least approximately 20%. It is particularly preferable if the envelope is disposed in the join and/or in the opening region of the airbag module cover.

In a further possible embodiment, the envelope extends over the side surface as far as the underside of the support material. The envelope is preferably laid around the side surface and around the underside. The envelope conceals the side surface preferably completely and the underside preferably by up to approximately 50%, in particular by up to approximately 30%, especially by up to approximately 10%.

A further embodiment according to the invention provides that the covering has at least one fold as the, and/or at the, cutting and/or joining points. The textile covering is preferably folded in the edge zone at an angle of up to approximately 180 degrees, in particular the edge and/or the cutting and/or joining points is/are concealed by the textile covering.

It is particularly preferred if the constructive device comprises a recess on the support material of the first and/or second cladding element in which the cutting and/or joining points of the envelope and/or the fold are disposed, the recess preferably being adapted to and/or being the same as a thickness of the textile covering. The recess preferably has the dimensions of the envelope and/or of the fold and/or the dimensions are adapted to the envelope and/or the fold. In particular, the support material in the recess is reduced by a thickness of the textile covering. Optionally, the recess can be disposed on the upper side, on at least one side surface, and/or on the underside of the support material of the first and/or the second cladding element. It is feasible that the recess is disposed in the join. It is also feasible that the recess is disposed in the opening region of the airbag module cover.

It is advantageous at the recess that a uniform transition is achieved between textile covering and support material of the first and/or the second cladding element and thus no unattractive bulge persists. Likewise, a smooth transition can be ensured between the first and the second cladding element. Furthermore, installation space can be saved by the recess.

In a further preferred embodiment, the constructive device comprises a canopy and/or border of the cutting and/or joining points. Optionally, the canopy and/or border is open toward the covering. It is also possible that the canopy and/or the border embraces the covering. The canopy and/or border preferably covers the cutting and/or joining points completely or partially. In particular, the canopy and/or the border with the upper side of the support material form a receiving region in which the cutting and/or joining points are disposed. In this case, the cutting and/or joining points can completely or partially fill the receiving region. Optionally the canopy and/or border can run parallel to the upper side of the support material and/or to the textile covering. It is also feasible that the canopy and/or border with the upper side and/or with the textile covering enclose an angle of preferably up to approximately 90 degrees, in particular of up to approximately 60 degrees, especially of up to approximately 30 degrees.

It is furthermore possible that the canopy and/or border is disposed on the support material of the first cladding element. Preferably the canopy and/or border is disposed on the upper side and/or a side surface of the support material. In particular, the canopy and/or border is disposed in the area of the join and/or adjoins the join. Especially the canopy and/or border is disposed in the opening region of the airbag module cover. It is also feasible that the cutting and/or joining points are low-pressure back-injection molded and the canopy and/or border is thereby formed.

It is also possible that the canopy and/or border is disposed on the support material of the second cladding element. In particular, the canopy and/or the border can cover and/or screen the area of the join. Optionally, the canopy and/or the border can be disposed on the upper side and/or a side surface of the second cladding element.

A further possible embodiment of the invention provides a constructive device which comprises at least one shoulder between the cutting and/or joining points and the support material. Preferably a tilt and/or arching and/or a channeling and/or a height offset of the support material of the first cladding element forms the shoulder.

In a further preferred embodiment, a tilt and/or arching and/or a channeling and/or a height offset of the support material of the second cladding element forms the shoulder. Preferably the tilt and/or the arching and/or the channeling and/or the height offset adjoin the join before which the cutting and/or joining points of the textile covering are disposed or the textile covering ends. In particular the cutting and/or joining points are separated by the join from the tilt and/or arching and/or channeling and/or the height offset of the support material of the second cladding element. It is also possible that the support material of the airbag module cover has a tilt and/or arching and/or channeling which adjoins the opening region and/or is disposed adjacent to the opening region.

It is conceivable that the tilt adjoins the cutting and/or joining points at an angle of preferably up to approximately 90 degrees, in particular of up to approximately 60 degrees, especially of up to approximately 30 degrees, wherein the angle of the upper side of the support material and/or the textile material and the tilt is included. The arching preferably has a radius of at least approximately 15 cm, in particular of at least approximately 20 cm, especially of at least approximately 25 cm.

Optionally between the edge and/or the cutting and/or joining points of the textile covering and the shoulder, there can be a distance of preferably up to approximately 10 mm, in particular of up to approximately 6 mm, especially of up to approximately 3 mm.

It is furthermore feasible that in the region of the shoulder a weakening is provided in the support material, in particular in the airbag module cover. The underside of the support material preferably has a recess and/or weakening. Especially the recess and/or the weakening forms the opening region of the airbag module cover.

It is advantageous that no separate device for protecting the cutting and/or joining points needs to be provided in the shoulder but that protection from detachment and/or wear can be achieved merely by a design-dependent shaping of the cladding elements. Furthermore, the textile covering does not require any separate, usually unattractive weakening, in order to fully ensure the opening function of the airbag module cover in the event of an activation of the airbag module. This is particularly possible since the edge of the textile covering is disposed in the shoulder and the textile covering therefore does not need to tear.

In a further preferred embodiment of the invention, the constructive device comprises an emblem that covers the cutting and/or joining points. In particular, the emblem is at least partially disposed on the cutting and/or joining points of the textile covering. Consequently, access to the cutting and/or joining points can be prevented and protection from detachment and/or wear can be ensured.

It is also possible that the emblem is disposed at least in part on the textile covering and/or on the upper side of the support material. Optionally, recesses in the emblem allow a view of the textile covering and/or the support material. Optionally, the emblem can be adhesively bonded, sewn, hooked, welded and/or fastened by other suitable fastening methods.

The emblem can, for example, comprise a refining element and/or an information medium. Thus, the emblem can comprise, for example, a sign, a letter, a logo, an image, and many more. The emblem preferably comprises a trademark and/or a reference to an airbag, for example, by the writing “airbag”. Possible materials of the emblem are plastic, rubber, metal, and/or textile materials, and many more.

In a preferred embodiment, the constructive element is disposed in and/or on the first cladding element. It is also possible that the constructive device is disposed in and/or on the second cladding element. It is furthermore feasible that the constructive device is disposed in the area of the join and/or in the opening region of the airbag module cover. Combinations of all the aforesaid constructive possibilities are also possible.

### BRIEF DESCRIPTION OF THE DRAWINGS

The present invention will hereinafter be described in conjunction with the following drawing figures, wherein like numerals denote like elements, and:

FIG. 1 shows a plan view of a steering wheel having a plurality of cladding elements;

FIG. 2 shows an airbag module cover of one variant of the steering wheel from FIG. 1;

FIG. 3 shows an emblem disposed on the airbag module cover of FIG. 2 and a section X-X through the emblem;

FIG. 4 shows a variant of the section X-X through the emblem from FIG. 3;

FIG. 5 shows a section through a cladding element from FIG. 1;

FIG. 6 shows a section through a first and a second cladding element of one variant of the steering wheel from FIG. 1;

FIG. 7 shows a detailed view of the beading from FIG. 6;

FIG. 7a shows a detailed view of a modification of the beading from FIG. 6;

FIG. 7b shows a detailed view of another modification of the beading from FIG. 6;

FIG. 8 shows a section A-a through a variant of the airbag module cover from FIG. 2;

FIG. 8a shows a section along the line of intersection A-A through a further modification of the airbag module cover from FIG. 2;

FIG. 8b shows a section along the line of intersection A-A through a further modification of the airbag module cover from FIG. 2;

FIG. 9 shows a detailed view of a modification of the opening region of the airbag module cover from FIG. 2;

FIG. 10 shows a section A-A through a further variant of the airbag module cover from FIG. 2;

FIG. 11 shows a section A-A through a further modification of the airbag module cover from FIG. 2;

FIG. 12 shows a detailed view of a modification of the opening region of the airbag module cover from FIG. 2.

### DETAILED DESCRIPTION

The following detailed description is merely exemplary in nature and is not intended to limit application and uses. Furthermore, there is no intention to be bound by any theory presented in the preceding background or summary or the following detailed description.

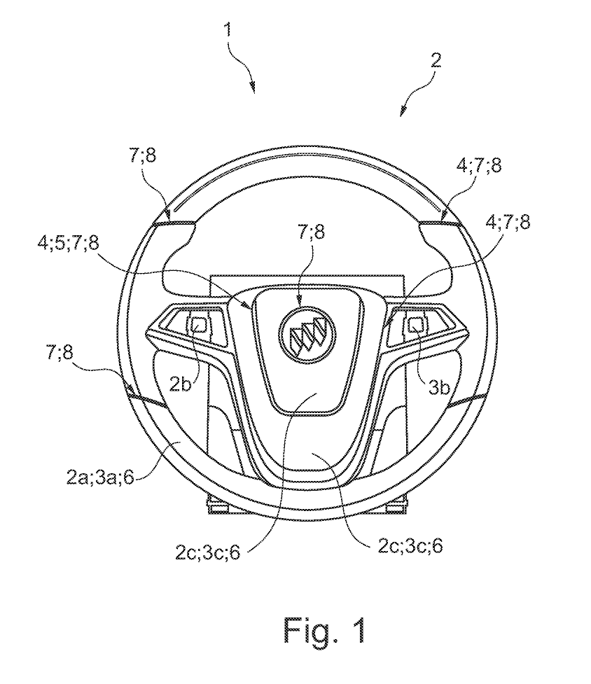

FIG. 1 shows a plan view of a steering wheel 1 for a vehicle, in particular for an automobile. The steering wheel 1 has a steering wheel skeleton 2 which comprises a steering wheel rim 2a, two steering wheel spokes 2b and a steering wheel hub 2c. Disposed in the area of the steering wheel hub 2c is an airbag module having an integrated airbag which can protect a vehicle driver from injuries in the event of an impact of the vehicle.

The steering wheel 1 has a plurality of cladding elements 3 which adjoin one another via joins 4. The cladding elements 3 are configures as a steering wheel rim cover 3a, two steering wheel spoke covers 3b, and an airbag module cover 3c.

The steering wheel spoke covers 3b comprise two electrical control elements, which have switches and/or levers and/or buttons and are connected via an electrical interface to an electrical device such as, for example, a radio or an air conditioning system. The airbag module cover 3c terminates the airbag module in the direction of the vehicle driver. It comprises a linearly configured opening region 5 which ensures an opening function of the airbag module cover 3c in the event of an activation of the airbag module and thus enables the airbag to escape from the airbag module.

The steering wheel rim cover 3a and the airbag module cover 3c have a textile covering 6, whereas the steering wheel spoke covers 3b have no covering 6. The textile covering 6 forms at least in part a viewing surface of the cladding elements 3. The textile covering 6 comprises natural and/or synthetic fibers, which form a surface structure such as a material, a woven fabric and/or a knitted fabric. In an alternative exemplary embodiment of the invention, the textile covering 6 comprises felt or nonwoven.

The textile covering 6 has cutting and/or joining points 7. The cutting and/or joining points 7 are disposed in an edge zone of the textile covering 6 and/or comprise a cut edge of the textile covering 6. The steering wheel 1 has a plurality of constructive devices 8 for receiving the cutting and/or joining points 7 and/or for screening the cutting and/or joining points 7.

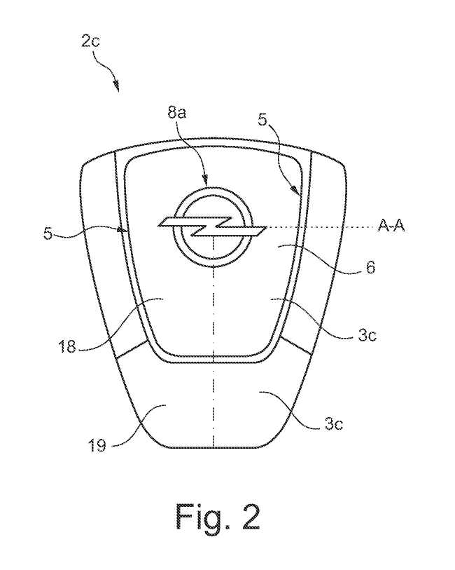

FIG. 2 shows a variant of the airbag module cover 3c from FIG. 1, wherein corresponding or the same parts in the figures are each provided with the same reference numbers. The airbag module cover 3c comprises two regions 18; 19 which are separated from one another by the linearly configured opening region 5. The first region 18 is disposed in the center of the airbag module cover 3c and has the textile covering 6 which forms a decorative and/or design surface. The second region 19 encloses the first region 18 and has no textile covering 6. An emblem 8a is attached in the first region 18. The emblem 8a is circularly configured and has a sign in the form of a lightning flash.

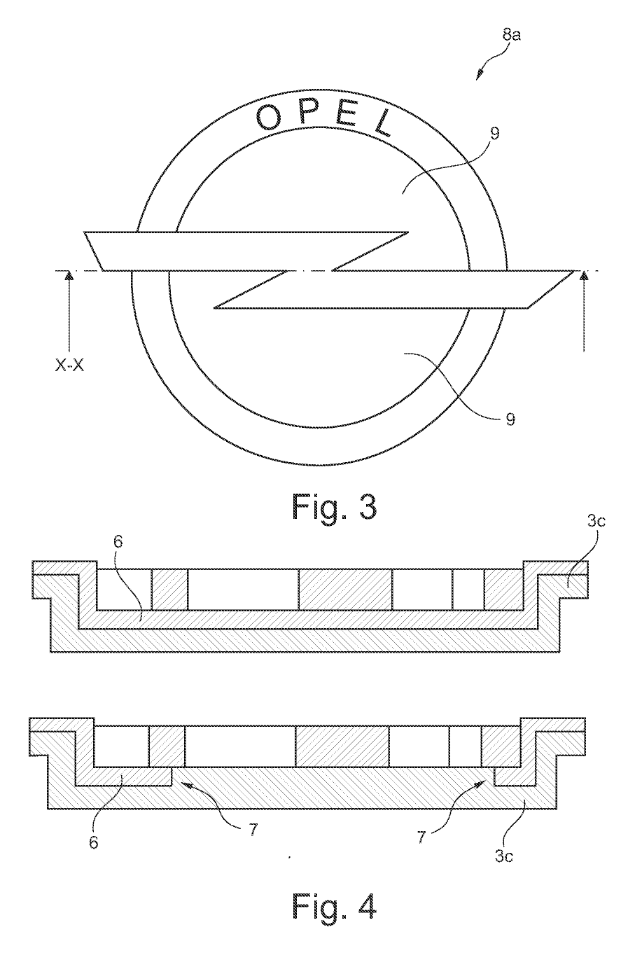

FIG. 3 shows the emblem 8a from FIG. 2 and a section along a line of intersection X-X through the emblem 8a. The emblem 8a has openings or passages 9 underneath and above the lightning flash. In particular, the emblem 8a is not completely closed. The textile covering 6 extends completely and/or continuously or uninterruptedly under the emblem 8a and has no cutting and/or joining points 7 in the region of the emblem 8a. The openings or passage 9 of the emblem 8a allow the vehicle driver to have a free view of the textile covering 6.

FIG. 4 shows the section X-X through the emblem 8a from FIG. 3, the emblem 8a being disposed on an alternative airbag module cover 3c from FIG. 2. Corresponding or the same parts in the figures are each provided with the same reference numbers. The textile covering 6 has cutting and/or joining points 7. The cutting and/or joining points 7 are disposed and/or fastened under the emblem 8a so that the emblem 8a forms a constructive device which receives and/or screen the cutting and/or joining points 7.

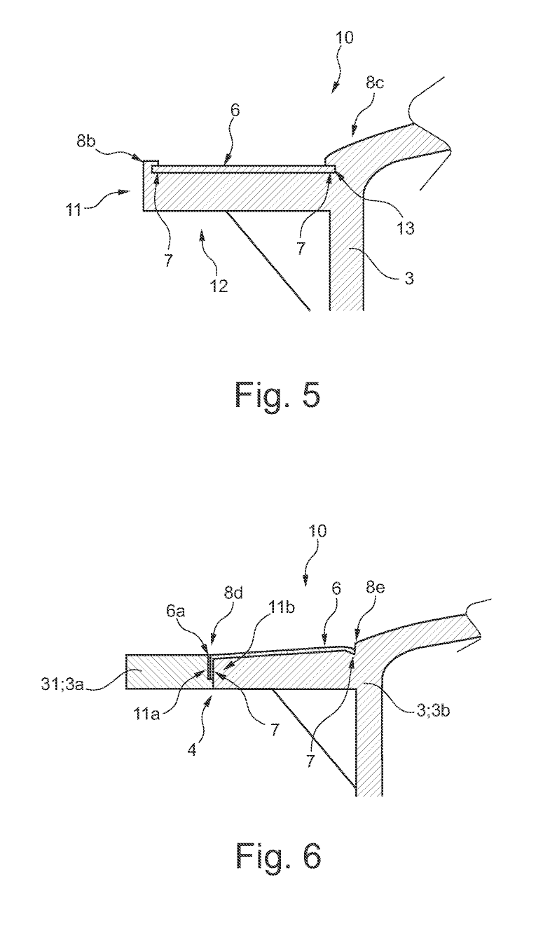

FIG. 5 shows a section through a cladding element 3 from FIG. 1, wherein corresponding or the same parts in the figures are each provided with the same reference numbers. The cladding element 3 comprises a support material that is formed from plastic and/or rubber, and has an upper side 10, a side surface 11, and an underside 12. The upper side 10 is facing the vehicle driver, the underside 12 is facing away from the vehicle driver and/or is arranged to be concealed for said driver.

Two constructive devices 8 are disposed on the upper side 10. A first constructive device 8 is formed as a low-pressure back injection molding 8b of the textile covering 6 which in the cross-section shown embraces the cutting and/or joining points 7 of the textile covering 6. The second constructive device 8 is configured as a canopy and/or border 8c, which forms a groove-shaped receptacle for the cutting and/or joining points 7. The constructive devices 8 have a length of at least approximately 5 mm, preferably of at least approximately 15 mm, in particular of at least approximately 30 mm, especially of at least approximately 50 mm. They cover the cutting and/or joining points 7 and protect them from becoming detached and/or wearing.

The canopy and/or border 8c forms a receiving region 13 in which the cutting and/or joining points 7 are disposed. The cutting and/or joining points 7 completely fill the receiving region 13. The canopy and/or border 8c with the upper side 10 and/or the textile covering 6 encloses an angle which is preferably up to approximately 90 degrees, in particular up to approximately 60 degrees, especially up to approximately 30 degrees.

FIG. 6 shows a section through a first and a second cladding element 3; 31 of one variant of the steering wheel 1 from FIG. 1, wherein corresponding or the same parts in the figures are each provided with the same reference numbers. The first cladding element 3 is configured as a steering wheel spoke cover 3b, the second cladding element 31 is configured as a steering wheel rim cover 3a. The steering wheel spoke cover 3b adjoins the steering wheel rim cover 3a via a join 4. The steering wheel rim cover 3a has no textile covering 6 whereas the steering wheel spoke cover 3b has a textile covering 6, which forms a visible and/or decorative surface on the support material. The textile covering 6 has cutting and/or joining points 7 at two ends. The first end is disposed in the direction of the steering wheel rim cover 3a, the second end is disposed in an opposite direction opposite from the steering wheel rim cover 3a. At the first end, the textile covering 6 has an envelope 6a as the, and/or at the, cutting and/or joining points 7. The envelope 6a is disposed in the join 4 and covers a side surface 11b of the steering wheel spoke cover 3b preferably by at least approximately 20%, in particular by at least approximately 50%, especially by at least approximately 75%.

The steering wheel rim cover 3a has a constructive device 8 which is configured as a recess 8d at the side surface 11a of the steering wheel rim cover 3a. The cutting and/or joining points 7 of the envelope 6a are disposed in the recess 8d. In particular, the recess 8d receives the cutting and/or joining points 7 of the envelope 6a. To this end, the recess 8d has a thickness of the textile covering 6 and/or it is adapted to the thickness of the textile covering 6. Hence, a smooth transition can be ensured between the steering wheel spoke cover 3b and the steering wheel rim cover 3a and/or installation space can be saved.

The steering wheel spoke cover 3b also has a constructive device 8 which is configured as a beading and/or groove 8e. The beading and/or groove 8e is disposed on the upper side 10 of the support material and there forms an indentation. The second end of the textile covering 6, in particular the cutting and/or joining points 7, are disposed in the beading and/or groove 8e.

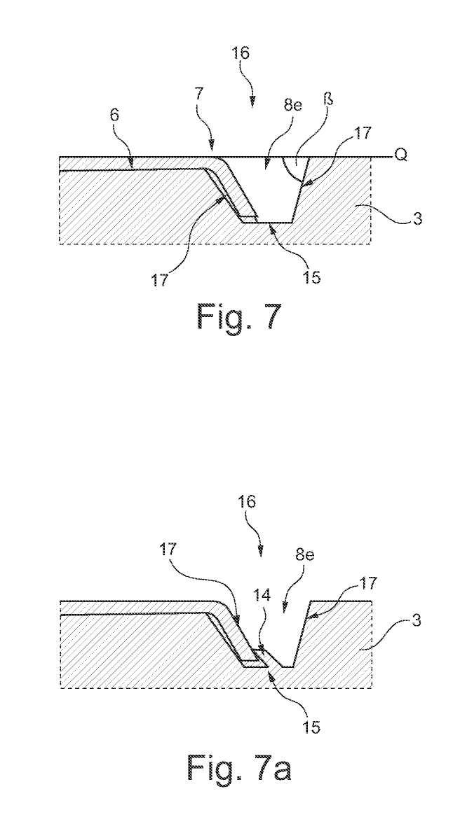

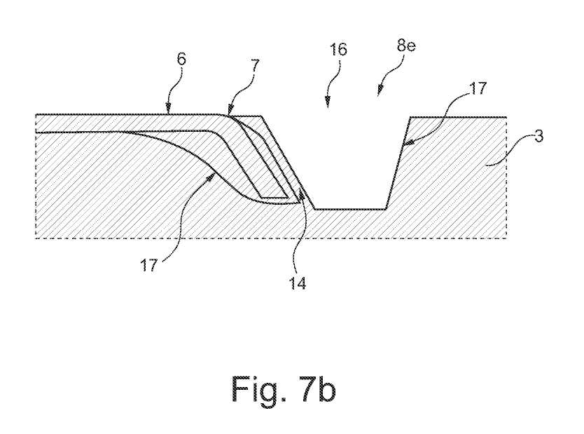

FIG. 7 shows a detailed view of the beading and/or groove 8e from FIG. 6. The beading and/or groove 8e is configured to be funnel-shaped and has a base 15, a side wall 17, and an opening 16, which is directed toward the upper side 10 of the airbag module cover 3c. The side wall 17 slopes downward from an imaginary plane Q through the upper side 10 at an angle β of approximately 70 degrees toward the base 15. The cutting and/or joining points 7 are disposed in the beading and/or groove 8e and/or adhesively bonded, an adhesive layer being restricted to the region between the wall 17 and the cutting and/or joining points 7.

FIG. 7a shows a detailed view of a modification of the beading and/or groove from FIG. 6. The beading and/or groove 8e has a lip 14. The lip 14 is disposed on the base 15 in the beading and/or groove 8e. The length of the lip is preferably less than approximately 50%, in particular less than approximately 25% of a beading and/or groove depth. The lip 14 encloses with the base 15 an angle of preferably approximately 65 degrees, in particular of approximately 45 degrees. The cutting and/or joining points 7 are disposed between the lip 14 and the base 15 or between the lip 14 and the side wall 17 and/or adhesively bonded.

FIG. 7b shows a detailed view of another modification of the beading and/or groove 8e from FIG. 6. The beading 8e is configured to be trough-shaped. It has a lip 14 whose length extends completely from the base 15 as far as the upper side 10 of the cladding element 3.

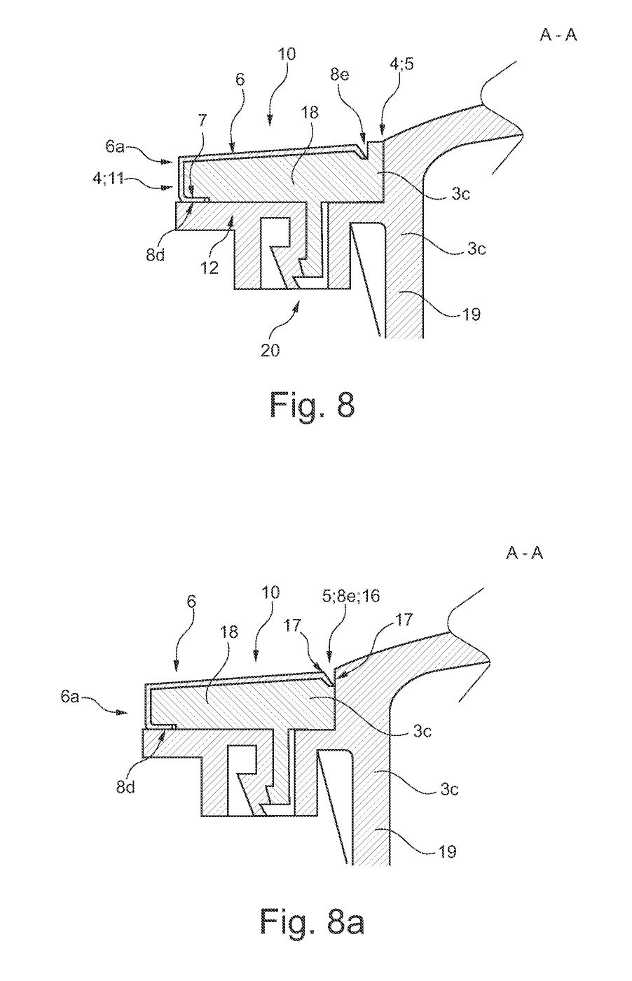

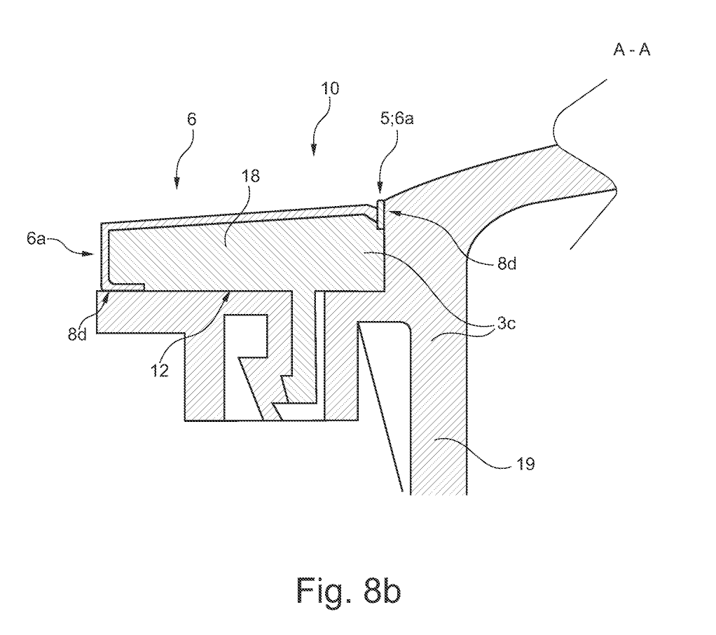

FIG. 8 shows a section along a line of intersection A-A through a variant of the airbag module cover 3c from FIG. 2. The first region 18 of the airbag module cover 3c has the textile covering 6. The second region 19 has no textile covering 6. It is separated by the opening region 5 for the airbag from the first region 18. The opening region 5 therefore serves simultaneously as join 4 between the two regions 18; 19.

The airbag module cover 3c has a snap closure 20 which can open in the event of an activation of the airbag module. The airbag module cover 3c opens in the opening region 5, whereby the first region 18 folds away laterally and allows the airbag to escape from the airbag module.

At one end the textile covering 6 has an envelope 6a as the, and/or at the, cutting and/or joining points 7. The envelope 6a is disposed in the join 4. It is folded about the side surface 11 and the underside 12 of the support material of the first region 18. The envelope 6a completely covers the side surface 11 and the underside 12 by preferably up to approximately 10%, in particular by up to approximately 30%, especially by up to approximately 50%. The underside 12 has a constructive device 8 which is configured as a recess 8d and in which the cutting and/or joining points 7 of the envelope 6a are disposed. The recess 8d is adapted to the dimension of the envelope 6a and/or is configured to receive the thickness of the textile covering 6. In particular, the recess 8d has a depth which corresponds to and/or is the same as the thickness of the textile covering 6. Thus, a smooth transition to the support material of the second region 19 can be ensured.

On the opposite side, the textile covering 6 has further cutting and/or joining points 7 which are disposed in a second constructive device 8. The second constructive device 8 is configured as a beading and/or groove 8e. The beading and/or groove 8e is disposed on the upper side 10 of the support material of the first region 18 in front of and/or near the opening region 5. The distance between the beading and/or groove 8e and the opening region 5 is preferably up to approximately 10 mm, in particular up to approximately 6 mm, especially up to approximately 3 mm.

FIG. 8a shows a section along the line of intersection A-A through a further modification of the airbag module cover 3c from FIG. 2. The textile covering 6 of the first region 18, as already described in FIG. 8, comprises the envelope 6a which is disposed in the constructive device 8 which is configured as recess 8d. The beading and/or groove 8e is disposed in the opening region 5 of the airbag module cover 3c. The side wall 17 of the beading and/or groove is formed by the support material of the first and the second region 18; 19. In particular, the opening 16 is formed by an indentation and/or recess in the support material of the first and second region 18; 19, wherein the indentation and/or recess is located in and/or adjacent to and/or adjoining the opening region 5 and/or broadens the opening region 5 toward the upper side 10.

FIG. 8b shows a section along the line of intersection A-A through a further modification of the airbag module cover 3c from FIG. 2. The textile covering 6 comprises the envelope 6a in each case on both sides of the first region 18. The two envelopes 6a are disposed in two constructive devices 8. The constructive devices 8 are configured as two recesses 8d which are located at both ends of the support material of the first region 18. Optionally, the envelope 6a can comprise the support material on one or both sides of the first region 18 entirely and/or as far as the underside. In this case, the recess 8d extends accordingly as far as the underside 12.

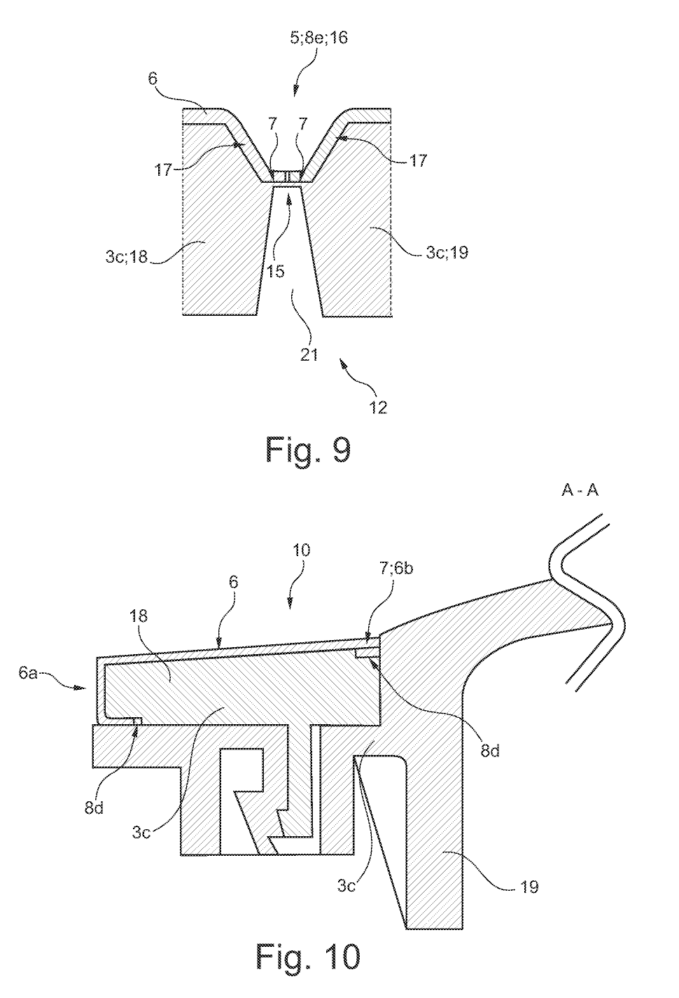

FIG. 9 shows a detailed view of a modification of the opening region 5 of the airbag module cover 3c from FIG. 2, wherein corresponding or the same parts in the figures are each provided with the same reference numbers. The beading and/or groove 8e is disposed in the opening region 5 of the airbag module cover 3c and broadens this toward the upper side 10 in a funnel shape. The support material of the first and the second region 18; 19 is flattened and/or removed in the opening region 5. It slopes downward at an angle of preferably up to approximately 90 degrees, in particular of up to approximately 60 degrees, especially of up to approximately 30 degrees toward the base 15 of the beading and/or groove 8e. The flattened and/or removed support material forms the side wall 17 of the beading and/or groove 8e. The opening 16 of the beading and/or groove 8e is formed by the recess and/or indentation in the support material of the first and the second region 18; 19.

The covering 6 is disposed on the support material of the first region 18 and on the support material of the second region 19 and there forms the visible surface. The cutting and/or joining points 7 of the covering 6 are disposed in the beading and/or groove 8e.

A weakening 21 is incorporated on the underside 12 of the support material, underneath the beading and/or groove 8e. The weakening 21 is suitable for and/or configured to ensure the opening function of the airbag module cover 3c in the event of an accident and/or impact by rupturing the support material. Such a weakening 21 can also be provided underneath the other opening regions 5 of the preceding figures.

FIG. 10 shows a section A-A through a further variant of the airbag module cover 3c from FIG. 2. In addition to the envelope 6a at one end of the textile covering 6 already described in FIG. 8, at the other end the textile covering 6 comprises a fold 6b as the, and/or at the, cutting and/or joining points. The other end of the textile covering 6 is folded in and/or folded over and thus doubled in the edge zone. The cutting and/or joining points 7 of the fold 6b are located underneath the textile covering 6. The constructive device 8 is also configured as recess 8d. The recess 8d is located on the upper side 10 of the support material of the first region 18. It is adapted to the dimension of the fold 6b and/or the same as this. Furthermore, the recess 8d is suitable for and/or configured to completely receive the fold 6b.

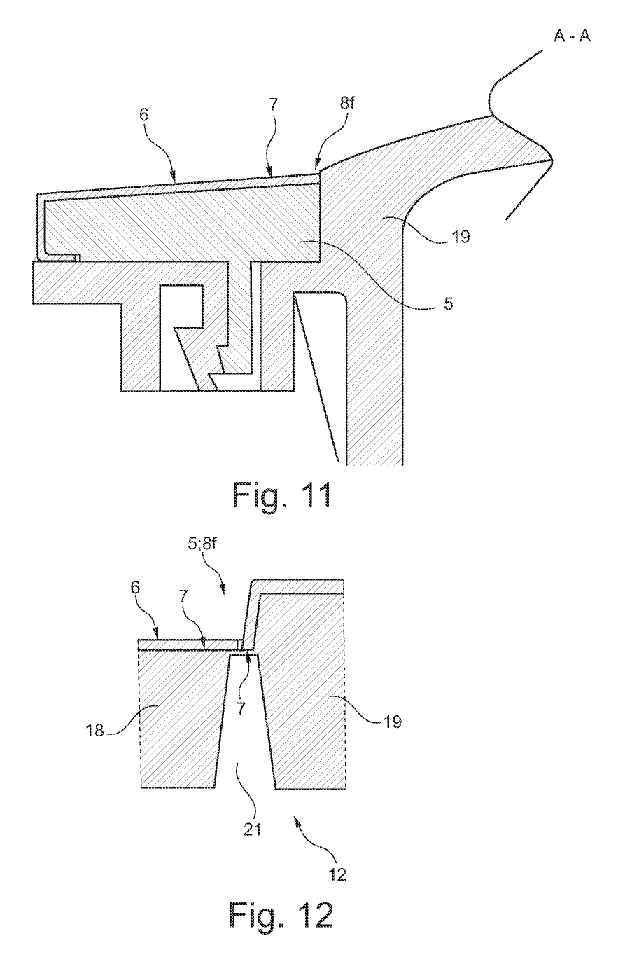

FIG. 11 shows a section A-A through a further modification of the airbag module cover 3c from FIG. 2. The constructive device 8 is achieved at one end of the textile covering 6 as already described in FIG. 8. At the other end of the textile covering 6, the constructive device 8 is configured as a shoulder 8f. The shoulder 8f is disposed between the cutting and/or joining points 7 and the support material of the second region 19. The shoulder 8f is formed by a tilt and a height offset of the support material of the second region 19. The height offset and the tilt adjoin the opening region 5 and/or are disposed adjacent to the opening region 5. The tilt adjoins the covering 6 at an angle of preferably up to approximately 90 degrees, in particular up to approximately 60 degrees, especially up to approximately 30 degrees.

FIG. 12 shows a detailed view of a modification of the opening region 5 of the airbag module cover 3c from FIG. 2, wherein corresponding or the same parts in the figures are each provided with the same reference numbers. The tilt of the shoulder 8f slopes from the upper side 10 of the second region 19 to the opening region 5 at an angle of up to approximately 90 degrees, preferably of up to approximately 60 degrees, especially up to approximately 30 degrees. The height offset is at least approximately 10 mm, preferably at least approximately 5 mm, in particular at least approximately 1 mm. The cutting and/or joining points 7 of the textile covering 6 are disposed in the opening region 5. The weakening 21 at which the support material ruptures in the event of an actuation of the airbag module is incorporated on the underside 12, in the opening region 5 or underneath the shoulder.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A steering wheel for a vehicle, comprising:
a first cladding element comprising a support material and a textile covering with points;
a visible surface of the first cladding element that is at least partially formed by the textile covering; and
a constructive device adapted to receive or screen the points.

2. The steering wheel according to claim 1, wherein the points are cutting points.

3. The steering wheel according to claim 1, wherein the points are joining points.

4. The steering wheel according to claim 1, further comprising a second cladding element is adjoined to the first cladding element with a join.

5. The steering wheel according to claim 1, wherein the constructive device comprises a beading.

6. The steering wheel according to claim 1, wherein the constructive device comprises a groove.

7. The steering wheel according to claim 5, the beading has a lip.

8. The steering wheel according to claim 6, wherein the points are fastened in the groove.

9. The steering wheel according to claim 1, wherein the textile covering comprises an envelope as the points that is laid around a side surface of the support material.

10. The steering wheel according to claim 1, wherein the textile covering comprises a fold as the points.

11. The steering wheel according to claim 1,
wherein the constructive device comprises a recess on the support material in which points are disposed,
wherein the recess has a recess thickness that is substantially the same as a textile covering thickness of the textile covering.

12. The steering wheel according to claim 11, wherein the recess is disposed on an upper side of the support material.

13. The steering wheel according to claim 1, wherein the constructive device comprises a canopy of the points.

14. The steering wheel according to claim 1, wherein the constructive device comprises a shoulder between the points and the support material.

15. The steering wheel according to claim 1, wherein the constructive device comprises an emblem that covers the points.

16. The steering wheel according to claim 1, wherein the constructive device is disposed with respect to the first cladding element.

17. The steering wheel according to claim 4, wherein the constructive device is disposed with respect to the second cladding element.

18. The steering wheel according to claim 4, wherein the constructive device is disposed in a region of the join.

19. The steering wheel according to claim 1, wherein the constructive device is disposed an opening region of an airbag module cover.
